(19) United States
(12) Patent Application Publication
(10) Pub. No.: US 2018/0295949 A1
(43) Pub. Date: Oct. 18, 2018

(54) Locking Device for Maintaining Seat Belt Tension on a Child Car Seat

(71) Applicant: Peter Damian Miller, Erindale (AU)

(72) Inventor: Peter Damian Miller, Erindale (AU)

(21) Appl. No.: 15/765,807

(22) PCT Filed: Sep. 6, 2016
(86) PCT No.: PCT/AU2016/000313

§ 371 Date: Apr. 4, 2018

(30) Foreign Application Priority Data
Oct. 5, 2015 (AU) 2015904035

(51) Int. Cl. A44B 11/25; B60N 2/28; B60R 22/02

(52) U.S. Cl. CPC A44B 11/2576; B60N 2/2812; B60N 2002/2815; B60R 2022/025; B60R 22/024

(57) ABSTRACT

A seat belt locking device (10) for a child car seat prevents relative movement of a typical automotive seat belt system, thereby maintaining tension upon the seat belt (8A) after the child car seat is installed to the vehicle. The device (10) described herein consists of a body (1) upon which pressure is applied and one or more keels (2) protruding from the body (1) inserted into the motor vehicle seat belt buckle tongue aperture (7) to prevent movement of the webbing strap (8A) through the buckle tongue aperture (7).

### RELATED APPLICATION

The present application claims priority from Australian Provisional Patent application number 2015904035, filed May 10, 2015 the entire contents of which are incorporated herein by reference.

### FIELD OF THE INVENTION

The present invention relates to a locking device for a vehicle seat belt securing a child car seat in the vehicle.

### BACKGROUND OF THE INVENTION

When a child rides in a motor vehicle, the law normally requires that the child travels in an approved child car seat appropriate for that child's size. Many child car seats are secured to the vehicle's seat by the corresponding seat belt for that seating position in the vehicle. The common method involves threading the tongue of the vehicle seat belt through a provided path in the child car seat, inserting it into the vehicle seat belt buckle and then tensioning the belt. With a lap belt only seat belt system, tension is achieved by pulling the vehicle seat belt strap through an adjuster mechanism. With the more common combination lap and shoulder type belt system, the vehicle seat belt is locked with an inertial type stopper that only activates during times of sudden acceleration or deceleration. In many situations the nature of the inertia type seat belt allows the tension of a vehicle seat belt securing a child car seat to reduce over time.

In the event of a sudden deceleration, as occurs in a vehicle impact, any slack in the vehicle seat belt will permit at least some forward travel of the child safety seat, resulting in potentially harmful shock loads for both the child car seat and, more importantly, its occupant. This slack may arise from normal use of the motor vehicle due to the adjustable nature of the inertia type seat belts.

There are existing devices currently available that convert the lap sash seat vehicle belt to a single belt length which is then used to retain the child car seat. These devices in the main are regarded as being difficult to install, adjust or remove. The consequence of this is that such devices often will not be used in a way that achieves their intended purpose.

Therefore, there is a need to provide a device for securing the lap portion of lap and shoulder type vehicle seatbelts while under tension when used to secure a child car seat that is simple to install, adjust or remove. It is against this background that the present invention has been developed.

Other objects and advantages of the present invention will become apparent from the following description, taken in connection with the accompanying drawings, wherein, by way of illustration and example, an embodiment of the present invention is disclosed.

The above descriptions of other inventions are of a general nature only to provide an understanding of the present invention.

### STATEMENT OF THE INVENTION

In one aspect, the invention provides a seat belt locking device for locking a vehicle seat belt. The locking device includes a body and at least one keel projecting from a surface of the body.

Preferably, the body and the keel are integral parts. However, it is achievable to form the locking device from more than on part.

In one embodiment, the keel extends at a 90 degree angle from the surface of the body.

The locking device may include a circular or disc shaped body and a wedge shaped keel. For example, the keel may include side walls which taper away from the body.

The locking device may include surface contours to assist in maintaining vehicle seat belt tension. In one embodiment the keel may include fins or corrugations, and in another embodiment the keel may be treated with sticky material.

Preferably, the locking device is a single component formed from a combination of plastic and/or rubber or any other suitable material designed to compress into the aperture for a tight fit.

The locking device is adapted to be used in conjunction with a vehicle seat belt and a child safety seat.

In one form, the device is operated by pressure applied to the body of the locking device to insert the keel into the vehicle seat belt buckle tongue aperture.

In one form at least one keel of the device may not necessarily be centrally located nor perpendicular to the surface of the body.

In one form at least one keel of the device may operate as an anchorage location for a secondary device to the vehicle seat belt buckle tongue.

In one form the locking effect is achieved by the wedging action of at least one keel against the webbing strap within the vehicle seat belt buckle tongue aperture.

In one embodiment the lap portion of the vehicle lap sash seat belt is maintained at a substantially fixed length.

### BRIEF DESCRIPTION OF THE DRAWINGS

The invention is described, by way of a non-limiting exemplary embodiment with the assistance of drawings wherein:

FIG. 1 is a perspective view of a seat belt locking device in accordance with the invention;

FIG. 2 is a side view of the locking device of FIG. 1;

FIG. 3 is a front view of the locking device of FIG. 1;

FIG. 4 is a view of the keel of the locking device of FIG. 1 aligned to a seat belt buckle tongue aperture during insertion;

FIG. 5 is a view of the locking device of FIG. 1 in situ;

FIG. 6 is a view of the locking device of FIG. 1 using the keel as an anchor; and

FIG. 7 is a front view of another embodiment of the locking device having multiple keels for ease of insertion, and surface contours to provide additional grip.

### DETAILED DESCRIPTION OF THE DRAWINGS

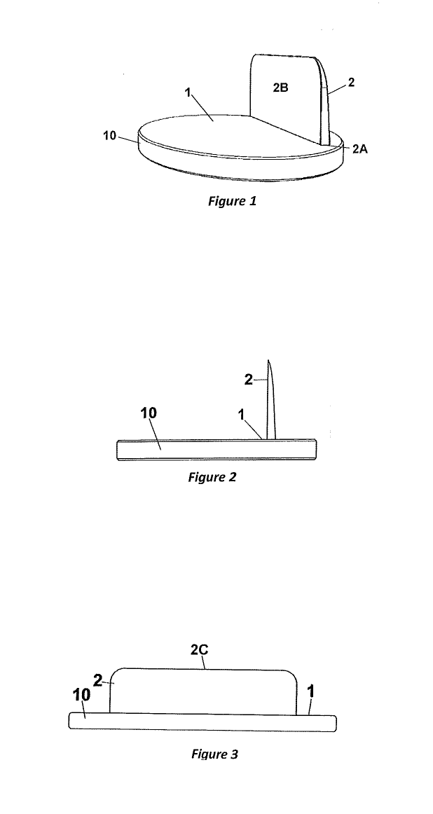

FIGS. 1 & 2 illustrate a seat belt locking device 10 in accordance with one embodiment of the present invention. The locking device 10 is adapted for use in conjunction with a vehicle seat belt 11 and a child safety seat (not shown). The locking device 10 includes a body 1 and a keel 2 which projects from the body 1.

The locking device 10 may be formed from a combination of plastic and/or rubber or any other suitable material. Preferably, the material is designed for a compressed fit to secure, or lock the seat belt.

The vehicle seat belt 11 includes a webbing strap 8, 8A, a tongue portion 3, and a buckle portion 4. The tongue portion 3 includes an aperture 7 configured to receive the webbing strap 8A to form sash portion 5 and lap portion 6. The tongue portion 3 is insertable within the buckle portion 4. FIG. 5 illustrates the tongue portion 3 having been inserted into the buckle portion 4.

The keel 2 has a generally rectangular base 2A with side walls 2B extending away from the base 2A and tapering to form a wedge shape. The wedge shape allows the keel 2 to be firmly positioned within the aperture 7 of the tongue portion 3. The keel 2 restricts movement of the webbing strap 8A relative to the tongue portion 3 resulting in a locking effect.

As best seen in FIGS. 2 and 3, the keel 2 projects substantially perpendicularly from the body 1. It will be understood however that alternative angles of incline to the body 1 may also be suitable. For example 70 degrees may also be suitable. Preferably, the long edge 2C of the keel 2 is substantially parallel to the body 1 however; the long edge 2C may be non-parallel to the body 1 in other embodiments of the invention.

FIG. 3 illustrates the device 10 with a single keel 2 however this does not preclude the device 10 from having multiple keels to facilitate easier insertion and still fall within the scope of the invention.

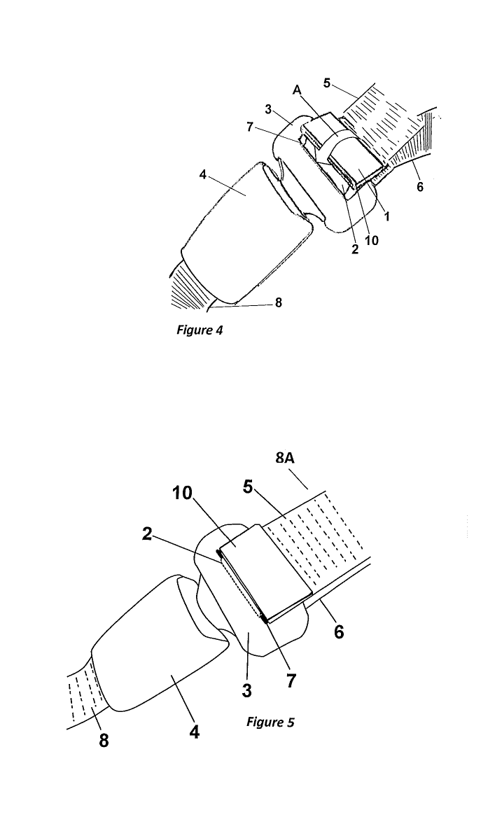

FIGS. 1 & 2 show one keel 2 substantially at a right angle to the body 1 however this does not restrict the locking device 10 from having alternative angles of incline to the body 1. Referring to FIG. 4 once the tongue portion 3 is locked into the buckle portion 4 and the webbing strap 8A is adjusted to the correct length, the locking device 10 is positioned by inserting the keel 2 into the 7 of the buckle tongue 3 in the direction of arrow A. As best seen in FIG. 4 the wedge shaped keel 2 is inserted into the aperture 7 to lock the lap belt 6 at the desired length so it is tightly secured to hold the child car seat (not shown) in position on the vehicle seat (not shown). The vehicle seat belt buckle 4 is attached to the webbing strap 8 whilst the seat belt buckle tongue 3 is connected to the vehicle seat belt buckle 4. The sash portion 5 of the vehicle seat belt is connected to the inertia reel of the vehicle (not shown) and tensioned as per normal.

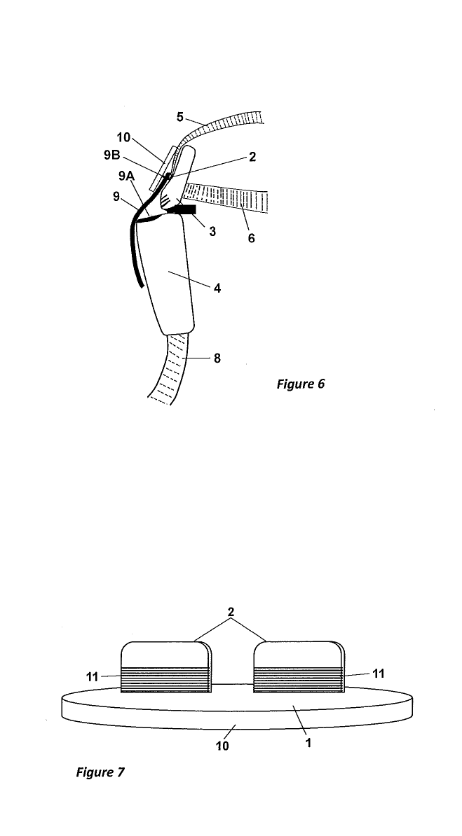

FIG. 6 illustrates the locking device 10 in situ with the keel 2 being used as an anchorage location for a secondary seat belt related device 9 such as a cover for the seat belt release button 9A. The cover 9 may be used to prevent the accidental release of the button 9A.

The keel 2 of the device 10 would pass through a slot 9B in the cover 9 to anchor it at the top and the adhesive would be used to fix the cover 9 to the seat belt buckle 4, thereby covering off the button 9A.

FIG. 7 illustrates another embodiment of the locking device 10. The locking device 10 includes a pair of keels 2 projecting from the body 1. The locking device 10 works in the same manner as a single keel; however, the pair of keels 2 provides more flexibility to positioning the locking device 10.

Referring still to FIG. 7, each keel 2 is substantially at a right angle to the body. It would be understood that other angles may also be suitable. Each keel 2 includes a surface contour having ridges 11 to provide additional grip. Other surface contours are also envisioned.

It will be appreciated by those skilled in the art that many modifications and variations may be made to the methods of the invention described herein without departing from the spirit and the scope of the invention.

Orientational terms used in the specifications such as vertical, horizontal, top, bottom, upper and lower are to be interpreted as relational and are based on the premise that the component, item, article, apparatus, device or instrument will usually be considered in a particular orientation, typically with the device uppermost.

What is claimed is:

1. A seat belt locking device for locking a vehicle seat belt and securing a child safety seat to a vehicle seat upon installation of the child safety seat, the vehicle seat belt including a tongue, a buckle and a webbing strap locatable about the child safety seat;
the locking device including:
a body; and
a wedge-shaped keel projecting substantially perpendicularly from the body, the keel having a tip and a thickness decreasing towards the tip;
wherein:
the locking device is configured such that in a locked position:
the body is positioned adjacent an aperture of the tongue;
the keel is firmly positioned within the aperture of the tongue;
the keel bears against the webbing strap without the webbing strap being inserted in the keel;
the body bears against the webbing strap;
the locking device secures the child safety seat to the vehicle seat by restricting movement of the webbing strap relative to the tongue aperture; and
in an unlocked position, the locking device is separate from the vehicle seat belt.

2. The locking device of claim 1, wherein the webbing strap includes a sash portion and a lap portion.

3. The locking device of claim 1, wherein the keel and the body are integral parts.

4. The locking device of claim 1, wherein the keel includes a base and side walls, the side walls tapering away from the base.

5. The locking device of claim 1, wherein the locking device includes two or more keels projecting from the body in a single keel plane.

6. The locking device of claim 1, wherein the keel and/or the body includes an uneven surface contour.

7. The locking device of claim 6, wherein the uneven surface contour for the keel includes ridges extending between opposing edges.

8. The locking device of claim 1, wherein the keel is located offset from a centre of the body.

9. The locking device of claim 1, wherein the body is planar.

10. The locking device of claim 9, wherein the body is circular, disc-shaped or rectangular.

11. The locking device of claim 1, wherein the keel is made from a material suitable to allow the keel to be compressed into the aperture for a tight fit in the locked position.

12. The locking device of claim 1, when combined with a secondary vehicle seat-belt related device.

13. The locking device of claim 12, wherein the secondary vehicle seat belt-related device is a cover for a release button for the vehicle seat belt.

14. The locking device of claim 12, wherein the keel provides anchorage for the secondary vehicle seat belt-related device.
